(19) United States
(12) Patent Application Publication
(10) Pub. No.: US 2008/0231167 A1
(43) Pub. Date: Sep. 25, 2008

(54) Display device and method of manufacturing the same

(76) Inventors: Seung-Hyun Son, Suwon-si (KR); Hyoung-Bin Park, Suwon-si (KR)

Correspondence Address: ROBERT E. BUSHNELL, 1522 K STREET NW, SUITE 300, WASHINGTON, DC, 20005-1202, US

(21) Appl. No.: 12/007,468

(22) Filed: Jan. 10, 2008

(30) Foreign Application Priority Data
Jan. 30, 2007 (KR) 10-2007-0009399

(51) Int. Cl. H01J 1/62; H01J 9/02

(52) U.S. Cl. 313/498; 445/24

(57) ABSTRACT

Provided is a highly efficient display device which can obtain a high luminous efficiency through low driving voltage. The display device includes a first substrate through which an image is displayed, a second substrate spaced apart from the first substrate by a predetermined interval, a plurality of transparent electrodes formed on the first substrate, a plurality of cathode electrodes which contact the transparent electrodes and extend parallel to the transparent electrodes, a plurality of gate electrodes which extend to cross the cathode electrodes, a plurality of electron emitters protruding from the transparent electrodes into a space between the first and second substrates through a plurality of apertures formed in regions in which the cathode electrodes and the gate electrodes overlap each other, a plurality of barrier ribs which are disposed between the first and second substrates and define one or more emission cells, a discharge gas which fills the emission cells and generates ultraviolet (UV) rays when electrons are emitted from the electron emitters, a plurality of emission layers which are formed on internal walls of the emission cells and are excited by the UV rays, and a visible-light reflection layer which is formed on the second substrate and reflects visible light generated by the emission layers toward the first substrate.

### CLAIM OF PRIORITY

This application makes reference to, incorporates the same herein, and claims all benefits accruing under 35 U.S.C. § 119 from an application for DISPLAY DEVICE AND METHOD OF MANUFACTURING THE SAME earlier filed in the Korean Intellectual Property Office on the 30^{th} of Jan. 2007 and there duly assigned Serial No. 10-2007-0009399.

### BACKGROUND OF THE INVENTION

1. Field of the Invention

The present invention relates to a display device and a method of manufacturing the same, and more particularly, to a display device using gas excitation, which improves luminous efficiency by using a low driving voltage, and a method of manufacturing the device.

2. Description of the Related Art

Plasma display panels (PDPs) are flat panel display devices which generate images using electric discharge and have excellent display properties in terms of luminance and viewing angle. Therefore, PDPs have been widely used for the flat panel display devices. In PDPs, gas excitation occurs between electrodes by direct or alternating current (AC or DC) voltages applied to the electrodes. Fluorescent materials are excited by ultraviolet (UV) rays generated by the gas excitation and, subsequently, visible light is emitted.

FIG. 1 is a cross-sectional view of a conventional PDP. Referring to FIG. 1, the PDP includes first and second substrates 10 and 20 which face each other, and a plurality of barrier ribs 14 which are disposed between the first and second substrates 10 and 20, and define a plurality of discharge cells 50. A pair of sustain electrodes 26 which generate a sustain discharge and a top dielectric layer 21 which covers the pair of the sustain electrodes 26 are disposed on an inner surface of the second substrate 20. An address electrode 12 which generates a supplementary discharge together with one of the sustain electrodes 26 and a bottom dielectric layer 11 which covers the address electrode 12 are disposed on an inner surface of the first substrate 10. A discharge gas (not shown) is filled in the discharge cells 50.

A plasma discharge is generated by ionizing the discharge gas between the pair of sustain electrodes 26 in which an AC voltage greater than a discharge starting voltage is applied. A plurality of gas particles are excited during the plasma discharge, and UV rays are generated while the excited gas particles are stabilized. The UV rays are converted into visible light by fluorescent materials 15 formed on internal walls of the discharge cells 50. The visible light is emitted through the second substrate 20 so as to form a predetermined image which can be recognized by a user.

However, because high energy is required to ionize the discharge gas, driving voltage of the PDP increases and emission efficiency decreases.

### SUMMARY OF THE INVENTION

The present invention provides an emissive display device using gas excitation, which improves luminous efficiency by using low driving voltage, and a method of manufacturing the device.

According to an aspect of the present invention, there is provided a display device including a first substrate through which an image is displayed, a second substrate spaced apart from the first substrate by a predetermined interval, a plurality of transparent electrodes formed on the first substrate, a plurality of cathode electrodes which conductively contact the transparent electrodes and extend parallel to the transparent electrodes, a plurality of gate electrodes which extend to cross the cathode electrodes, a plurality of electron emitters protruding from the transparent electrodes into a space between the first and second substrates through a plurality of apertures formed in regions in which the cathode electrodes and the gate electrodes overlap each other, a plurality of barrier ribs which are disposed between the first and second substrates and define one or more emission cells, a discharge gas which fills the emission cells and generates ultraviolet (UV) rays when electrons are emitted from the electron emitters, a plurality of emission layers which are formed on internal walls of the emission cells and are excited by the UV rays, and a visible-light reflection layer which is formed on the second substrate and reflects visible light generated by the emission layers toward the first substrate.

The electronic emitters may be composed of carbon nano-tubes (CNTs). The electron emitters may be formed on the transparent electrodes exposed by the apertures. The visible light generated by the emission layers may be emitted out of the first substrate through the apertures. One or more apertures may be formed on each of the emission cells. Each of the cathode electrodes and the gate electrodes may be composed of a conductive-metallic material.

The display device of the present invention may further include a dielectric layer formed between the cathode electrodes and the gate electrodes. The apertures may be formed to penetrate the dielectric layer. The dielectric layer may be composed of a material comprising SiO₂.

The visible-light reflection layer may include a thin conductive-metallic material. The visible-light reflection layer may include a conductive material so as to be maintained at a floating status by blocking a voltage applied from an external device. The visible-light reflection layer may include a conductive material and an anode voltage may be applied to the visible-light reflection layer from an external device. Voltage (V₁) applied to the cathode electrodes, voltage (V₂) applied to the gate electrodes, and voltage (V₃) applied to the visible-light reflection layer may satisfy the relationship of V₁<V₂≦V₃. The emission layers may be formed on sidewalls of the barrier ribs and on a portion of the visible-light reflection layer exposed to the emission cells.

According to another aspect of the present invention, there is provided a method of manufacturing a display device, the method including steps of forming a transparent electrode layer on a first substrate, forming first and second electrode layers on the transparent electrode layer and forming a dielectric layer between the first and second electrode layers, forming an aperture which has an inclined surface by etching portions of the first and second electrode layers and the dielectric layer so as to expose the transparent electrode layer, forming a photoresist layer on the transparent electrode layer, the inclined surface of the aperture, and the second electrode layer, forming an opening in a portion of the photoresist layer corresponding to the transparent electrode layer by selectively removing the photoresist layer, forming a photosensitive CNT layer having a flat top.

surface on the photoresist layer so as to fill the aperture, removing the photosensitive CNT layer excluding a portion of the photosensitive CNT layer, the portion hardened by applying UV rays from a lower surface of the first substrate through the opening of the photoresist layer, and burning and activating the remaining portion of the photosensitive CNT layer.

The step of forming of the aperture may include forming a photoresist layer in which a opening pattern is formed, on the second electrode layer, etching the second electrode layer and the dielectric layer using the photoresist layer as an etching mask, and removing a portion of the second electrode layer which protrudes over an upper surface of the dielectric layer and a portion of the first electrode layer which is exposed through the dielectric layer, using the dielectric layer as an etching mask.

A width of the aperture formed around an interface between the dielectric layer and the second electrode layer may be larger than a width of the aperture formed around an interface between the dielectric layer and the first electrode layer. A width of the opening formed on the second photoresist layer may be smaller than a width of the portion of the transparent electrode layer being exposed through the aperture.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a cross-sectional view of a plasma display panel (PDP);

FIG. 2 is an exploded perspective view of a display device according to an embodiment of the present invention;

FIG. 3 is a cross-sectional view of the display device of FIG. 2 cut along a line III-III of FIG. 2, according to an embodiment of the present invention;

FIG. 4 is a graph illustrating energy levels of Xe as an example of a discharge gas for generating ultraviolet (UV) rays, according to an embodiment of the present invention;

FIG. 5 is a cross-sectional view of a conventional top-gate display device as a comparative example of a display device according to an embodiment of the present invention;

FIG. 6 is a photographic image illustrating arrangements of apertures in a display device according to an embodiment of the present invention;

FIG. 7 illustrates an example of waveforms of voltages applied to a display device according to an embodiment of the present invention; and

FIGS. 8A through 8L are cross-sectional views illustrating a method of manufacturing the display device of FIG. 2, according to an embodiment of the present invention.

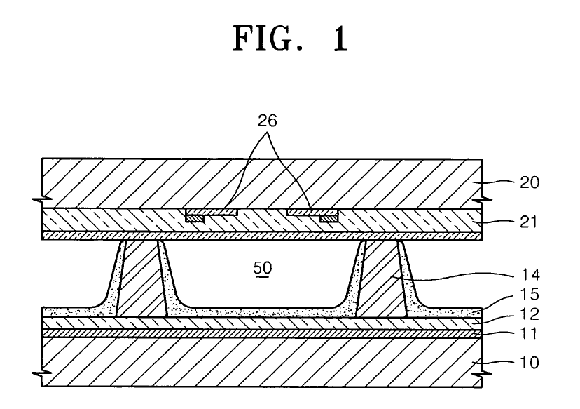

### DETAILED DESCRIPTION OF THE INVENTION

Hereinafter, the present invention will be described in detail by explaining embodiments of the invention with reference to the attached drawings.

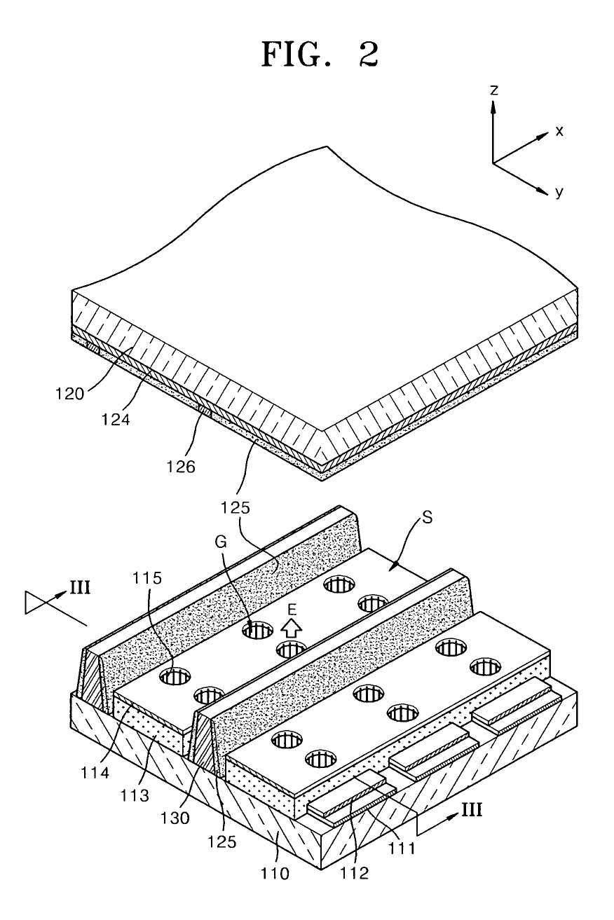

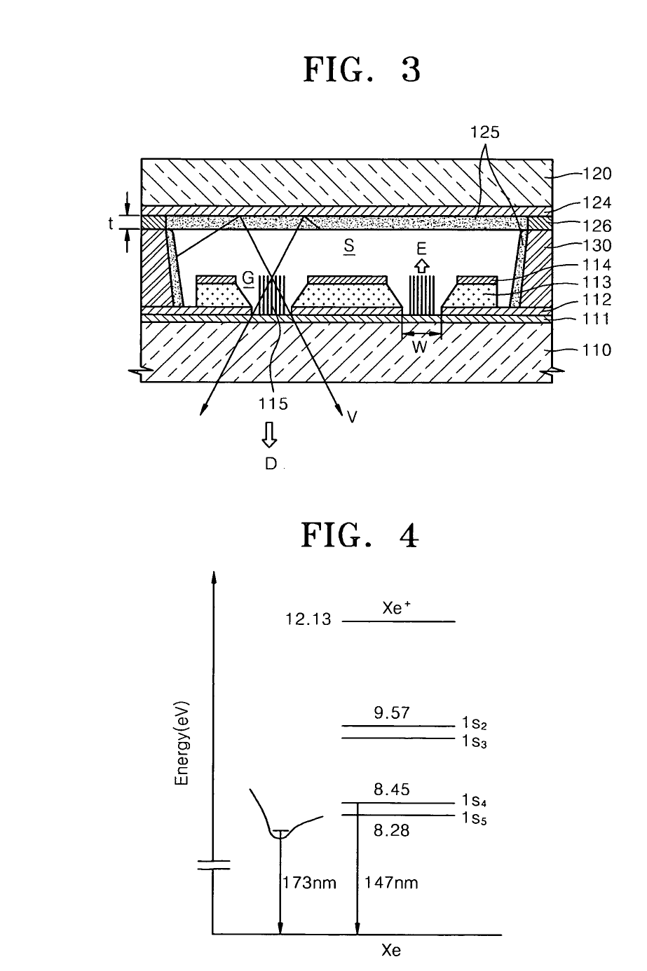

FIG. 2 is an exploded perspective view of a display device constructed as an embodiment of the present invention. FIG. 3 is a cross-sectional view of the display device of FIG. 2 cut along a line III-III of FIG. 2, according to an embodiment of the present invention.

Referring to FIGS. 2 and 3, first and second substrates 110 and 120 are spaced apart from each other by a predetermined distance. Each of the first and second substrates 110 and 120 may be a glass substrate or a flexible substrate composed of an optically transparent polymer. In particular, since images are displayed through the first substrate 110, the first substrate 110 may be composed of a transparent material having high visible light transmittance.

A plurality of transparent electrodes 111 composed of an optically transparent and conductive material are formed to extend in a first direction (y-direction) parallel to each other. A plurality of first electrodes 112 are formed on the transparent electrodes 111 parallel to each other so as to conductively contact the transparent electrodes 111. The first electrodes 112 function as cathode electrodes and a voltage applied to the first electrodes 112 is transferred to the transparent electrodes 111 which contact the first electrodes 112. The first electrodes 112 may be composed of a metal having good conductivity, such as Ag, Au, Al or Cu. The first electrodes 112 are covered by a dielectric layer 113.

A plurality of second electrodes 114, functioning as gate electrodes, are formed on the dielectric layer 113 to extend in a second direction (x-direction) parallel to each other so as to cross the first electrodes 112. The second electrodes 114 are formed to a predetermined height so as to be adjacent to tips of a plurality of electron emitters 115, thereby forming a top-gate structure. Images can be displayed in terms of grayscale values in a passive-matrix (PM) operation enabled by extending the first and second electrodes 112 and 114 to choose emission cells S that emit light. The second electrodes 114 may also be composed of a conductive metal such as Ag, Au, Al or Cu.

In regions in which the first and second electrodes 112 and 114 overlap each other, the electron emitters 115 are formed so as to protrude from the transparent electrodes 111. Preferably, the electron emitters 115 can be composed of carbon nano-tubes (CNTs). The electron emitters 115 emit electron beams E from pointed tips of the electron emitters 115. To expose the tips of the electron emitters 115, a plurality of apertures G are formed in the regions in which the first and second electrodes 112 and 114 overlap and in the regions of the dielectric layer 113 corresponding to the regions in which the first and second electrodes 112 and 114 overlap. The tips of the electron emitters 115 are separated from the second electrodes 114 by predetermined intervals so as not to be shorted by the second electrodes 114.

Visible light V is generated by an emission of a plurality of electrons and are transmitted externally (in a D-direction) through the apertures G, thereby forming a predetermined image. In the display device in which the predetermined image can be viewed through the first substrate 110, the wider the width W of the apertures G, the more visible light V can be transmitted. In this sense, luminous efficiency increases in proportion to the ratio of the total area of the apertures G to the entire display area (hereinafter, the ratio is referred to as an aperture ratio). Since a large amount of optical loss would be generated while visible light V is transmitted through the opaque first and second electrodes 112 and 114 and the dielectric layer 113 having a low transparency, the luminous efficiency of the display device increases as the total area of the apertures G, which are formed in the first and second electrodes 111 and 112 and the dielectric layer 113, increases.

Meanwhile, a plurality of barrier ribs 130 are formed on the first substrate 110 so as to partition the space between the first and second substrates 110 and 120 into a plurality of emission cells S. A plurality of open-type barrier ribs 130 which extend in the second direction (x-direction) and have stripe patterns are illustrated in FIG. 2. However, the present invention is not limited thereto, and a variety of closed-type barrier ribs having matrix patterns can be used. A gas is filled in the emission cells S as a source of ultraviolet (UV) rays. A primary, secondary, tertiary or more combined gas including Xe, N₂, D₂, CO₂, H₂, Kr or the like, or atmospheric air can be used.

FIG. 4 is a graph illustrating energy levels lS₅, lS₄, lS₃ and lS₂ of Xe as an example of a discharge gas for generating. UV rays, and an energy level required for an excited status Xe⁺. A mechanism for generating UV rays in accordance with energy levels of Xe and transitions of excited and ground states is well known, and thus detailed descriptions thereof will be omitted. The graph of FIG. 4 will be described in conjunction with the display device of FIGS. 2 and 3.

With regard to a low-voltage operation according to an embodiment of the present invention, approximately 8.28-12.13 eV is required to generate UV rays by exciting Xe. Ionizing Xe for a gas discharge to generate UV rays, however, requires at least approximately 12.13 eV. That is, a gas excitation requires lower energy than the gas discharge. Thus, in the display device of the present invention that uses gas excitation, a voltage, which is lower than the voltage required in a conventional gas-discharge display device, is needed to drive the display device.

Referring to FIGS. 2 and 3, a plurality of emission layers 125 are formed on internal walls of the emission cells S. According to the current embodiment of the present invention, the emission layers 125 are formed on sidewalls of the barrier ribs 130 and on a lower (or inner) surface of the second substrate 120. The emission layers 125 convert the UV rays generated by the gas excitation into visible light V. The emission layers 125, which includes layers for different colors, are respectively formed on adjacent emission cells S such that each of the emission cells S emits visible light having a different color from adjacent emission cells S. For example, three emission cells S, in which red, green and blue emission layers are respectively formed, form one unit pixel. A full-color display can be realized by controlling the emissive intensities of visible light emitted from the emission layers 125. Meanwhile, the adjacent emission layers 125 can be physically or optically separated from each other by a plurality of black stripes 126. The black stripes 126 may include a material with dark color which can absorb external light easily so as to prevent a deterioration of visibility of the image.

A visible-light reflection layer 124 may be formed on a lower surface of the second substrate 120. The visible-light reflection layer 124 may be formed to cover the entire surface of the second substrate 120, thus covering the plurality of the emission cells S. The visible-light reflection layer 124 may be composed of a metallic material having high reflectivity. For example, the visible-light reflection layer 124 may be a thin Al layer. The visible-light reflection layer 124 increases luminance of the image by reflecting visible light generated by a series of emission processes toward the first substrate 110, that is, to a region in which the image is displayed.

For example, the visible-light reflection layer 124 composed of a metallic material can function as an anode electrode when a uniform voltage is applied from an external device as described below.

The electrons emitted from the electron emitters 115 by high electric fields formed between the first and second electrodes 112 and 114 can be accelerated to the second substrate 120 due to a constant voltage of the visible-light reflection layer 124. In this sense, the visible-light reflection layer 124 can perform as the anode electrode. Although the visible-light reflection layer 124 is floated by blocking the voltage applied from the external device, the visible-light reflection layer 124 can function as the anode electrode to accelerate the electrons or, at least, function as an auxiliary electrode that promotes excitation of a gas by activating movements of a plurality of charged particles, by an induction voltage induced by the adjacent electrodes 112 and 114. Assuming that the visible-light reflection layer 124 functions as the anode electrode, hereinafter, the visible-light reflection layer 124 will be referred to as a reflection electrode 124.

The display device of FIG. 2 displays the predetermined image by an emission process as follows. If a predetermined voltage is applied to the first and second electrodes 112 and 114, the electron beams E are emitted from the electron emitters 115 in response to the high electric fields formed between the first and second electrodes 112 and 114. The electron beams E collide with gas particles filled in the emission cells S such that the gas is excited, thereby generating UV rays. Then, the UV rays are converted into the visible light V through emission layers 125. The visible light transmits through the first substrate 111 so as to form the predetermined image. Here, the visible light V generated by the emission layers 125 is radiated in all directions arbitrarily in a broad range of radiation angles. The visible light V toward the second substrate 120 is reflected by the reflection electrode 124 toward the first substrate 110 such that the luminous efficiency can be improved.

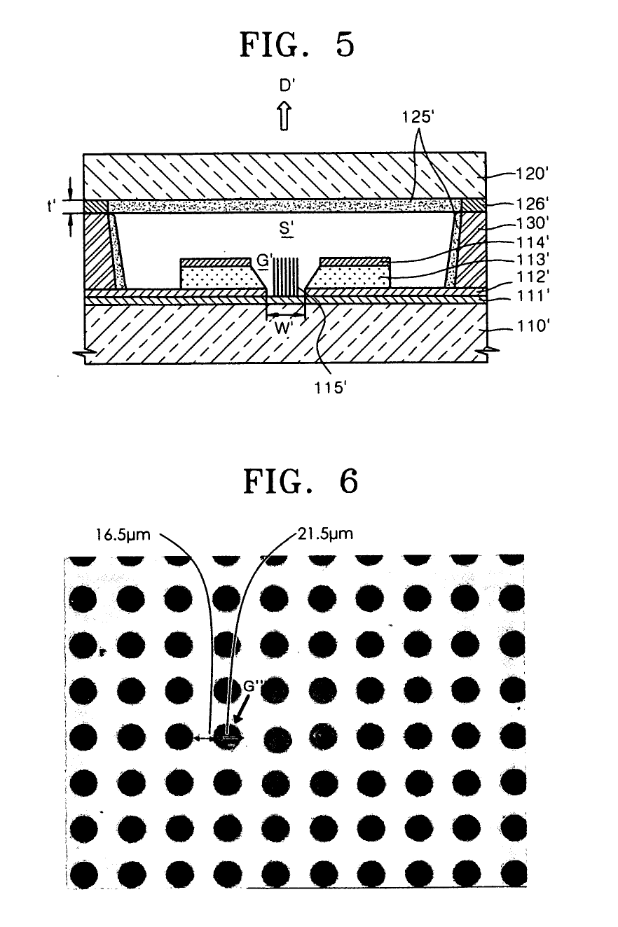

FIG. 5 is a cross-sectional view of a top-gate display device as a comparative example of a display device. Referring to FIG. 5, the top-gate display device includes first and second substrates 110′ and 120′ which are spaced apart from each other by a predetermined interval, and a plurality of barrier ribs 130′ which are disposed between the first and second substrates 110′ and 120′ and define a plurality of emission cells S′. A plurality of transparent electrodes 111′ are formed on the first substrate 110′ and a plurality of first electrodes 112′ are formed on the transparent electrodes 111′ so as to contact the transparent electrodes 111′. A dielectric layer 113′ is formed on the first electrodes 112′ and a plurality of second electrodes 114′ are formed on the dielectric layer 113′. A plurality of electron emitters 115′, which contact the transparent electrodes 111′, are exposed to the emission cells S′ through a plurality of apertures G′ formed to penetrate the first electrodes 112′, the dielectric layer 113′ and the second electrodes 114′. A plurality of emission layers 125′ are formed on sidewalls of the barrier ribs 130′ and on a lower surface of the second substrate 120′. Adjacent emission layers 125′ can be separated from each other by a plurality of black stripes 126′ disposed between the emission layers 125′. The top-gate display device of FIG. 5 is a transmissive type display device in which a predetermined image is displayed by visible light transmitted externally through the second substrate 120′ (in a D′-direction). In general, an emission layer 125′, in which UV rays are sources of excitation, has low visible light transmittance such that a thickness t′ of the emission layers 125′ formed on the second substrate 120′ is limited to be fixed.

However, as well-known, although the emission layer 125′ is formed as thin as possible, the transmittance ratio of the emission layer 125′ is equal to or lower than 2%. Thus, a large amount of optical loss occurs due to light transmitted through the emission layers 125′.

In the display device according to the present invention shown in FIGS. 2 and 3, the apertures G are formed so as to penetrate the first and second electrodes 112 and 114, and light, which is generated from emission layer or reflected from visible-light reflection layer, transmits toward the first substrate through the apertures G. Accordingly, the optical loss can be minimized, because there is no light absorbing layer through the transmission of the visible light toward the first substrate. Furthermore, since the transmittance of the visible light is not required to be considered, the thickness t of the emission layers 125 may be as thick as possible, thereby improving a conversion efficiency of the visible light.

Meanwhile, in a comparative example, the diameter W′ of each of a plurality of apertures G′ is only approximately 14 μm and the number of the apertures G′ formed in each of a plurality of emission cells is such that an aperture ratio for an entire display area of the display device is approximately 2%. As a result, the transmittance of visible light through the apertures G′ is measured as being almost 0%.

FIG. 6 is a photographic image of a real-product sample showing arrangements of apertures G″ in a display device constructed as an embodiment of the present invention. Referring to FIG. 6, the diameter of the apertures G″ is approximately 21.5 μm, and the number of apertures G″ that can be formed at each emission cell is six times greater than that of the comparative example. Accordingly, the aperture ratio is approximately 30% and the real transmittance of the visible light is approximately 15%. Thus, sufficient emission luminance can be obtained when the aperture ratio is equal to or greater than 30%.

Hereinafter, the operation of the display device of FIG. 2 will be described in detail. FIG. 7 shows an example of waveforms of voltages applied to a first electrode, a second electrode and a reflection electrode according to an embodiment of the present invention. The waveforms of FIG. 7 will be described in conjunction with the display device of FIGS. 2 and 3. Referring to FIG. 7, reference numerals V₁, V₂ and V₃ denote the voltages applied to one of the first electrodes 112, one of the second electrodes 114, and the reflection electrode 124, respectively. If pulse voltages are applied to the first and second electrodes 112 and 114 as illustrated in FIG. 7, the electron beams E are emitted through the corresponding electron emitters 115. By applying the voltages V₁, V₂ and V₃, such that V₁<V₂≦V₃, to the first and second electrodes 112 and 114 and the reflection electrode 124, respectively, the electron beams E emitted into an emission cell S can be accelerated in a proceeding direction of the electron beams E by an electric attraction of the reflection electrode 124. Here, the amount of electrons and energy of the electron beams can be controlled by voltage applied between the first and second electrodes 112 and 114, which perform as a cathode electrode and a gate electrode, respectively. Also, additional energy can be controlled by the reflection electrode 124 which functions as an anode electrode. A fixed ground voltage can be applied to the reflection electrode 124.

As described above, the energy which is applied to each of the first and second electrodes 112 and 114 may be greater than an energy level required to excite gas particles and less than an energy level required to ionize the gas particles, according to an embodiment of the present invention. However, the present invention should not be interpreted as being limited to exclude a gas discharge operation in accordance with ionization of the gas particles. For example, by repeatedly applying a discharge pulse between the reflection electrode 124 and the first electrode 112 which are separated to correspond to each emission cell S, high electric fields are formed in order to generate discharge between the reflection electrode 124 and the first electrode 112. Also, by applying additional electron beams E using the electron emitters 115, a gas discharge can be generated even by a low voltage, and more UV rays can be generated.

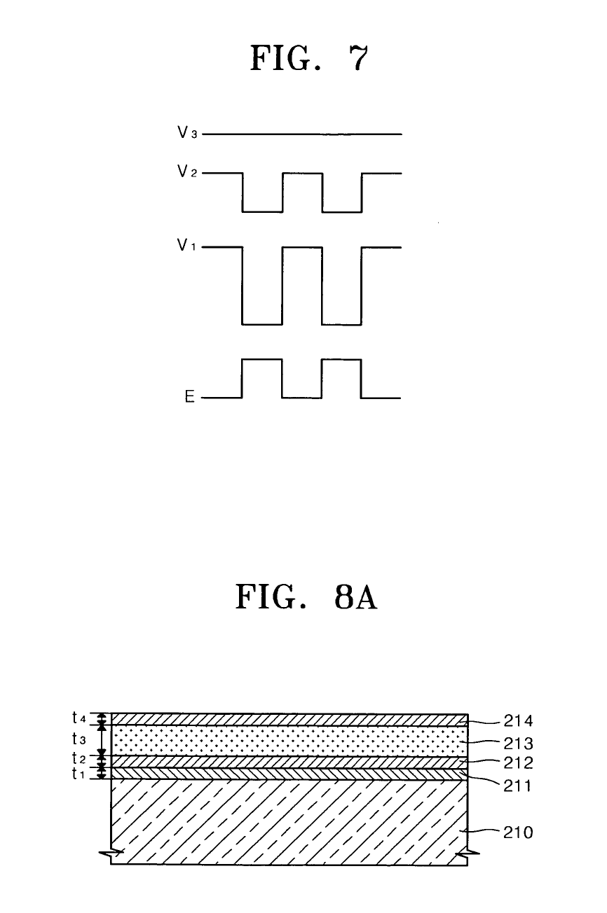

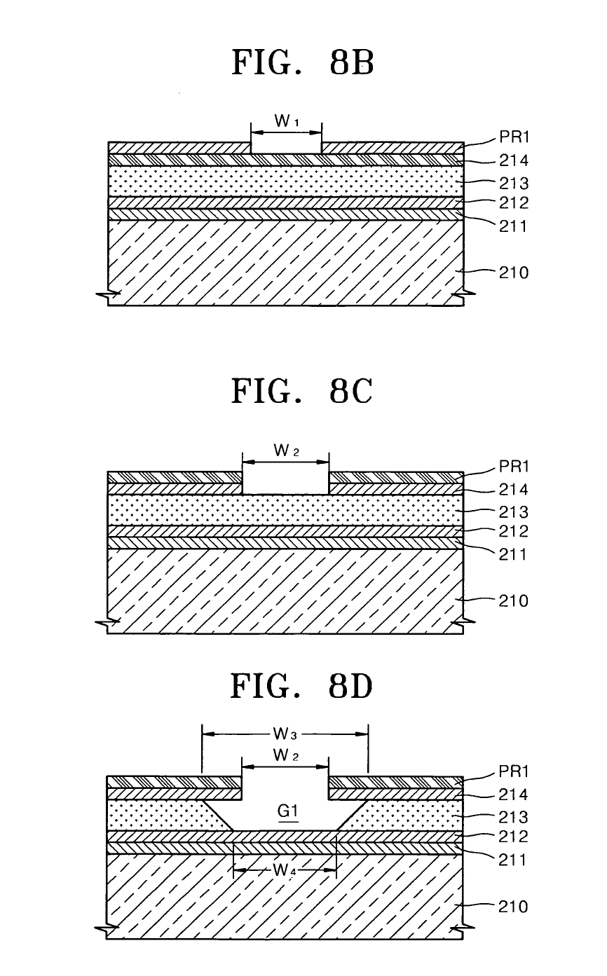

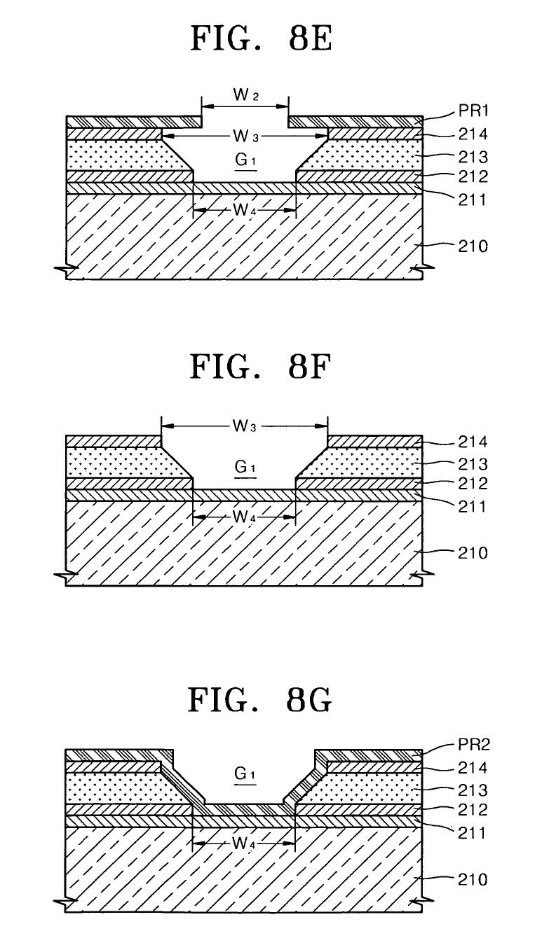

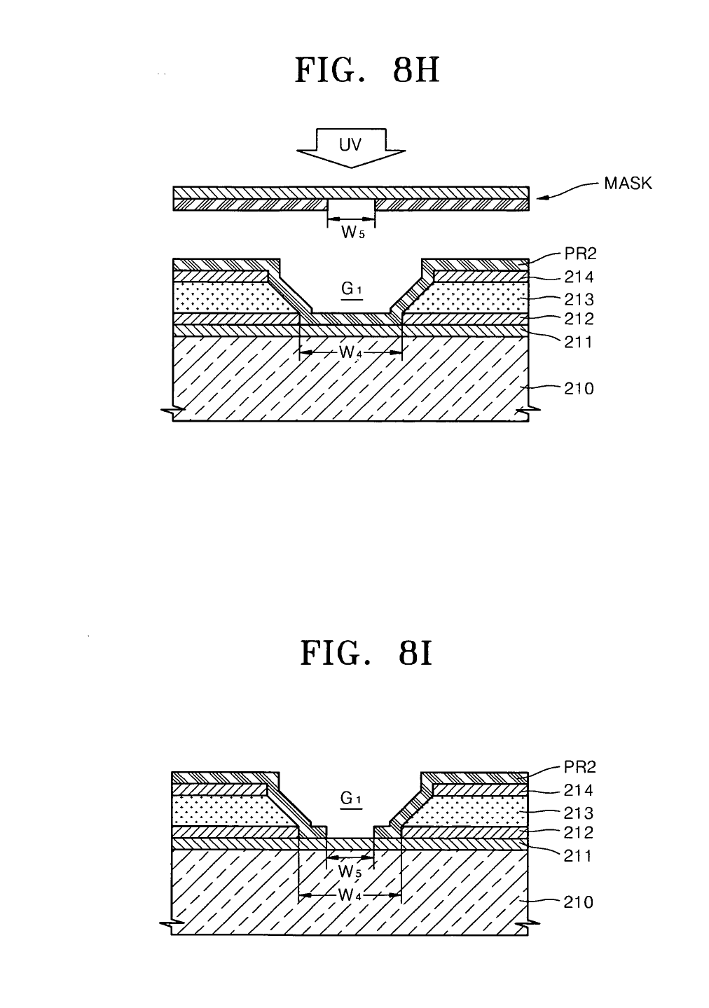

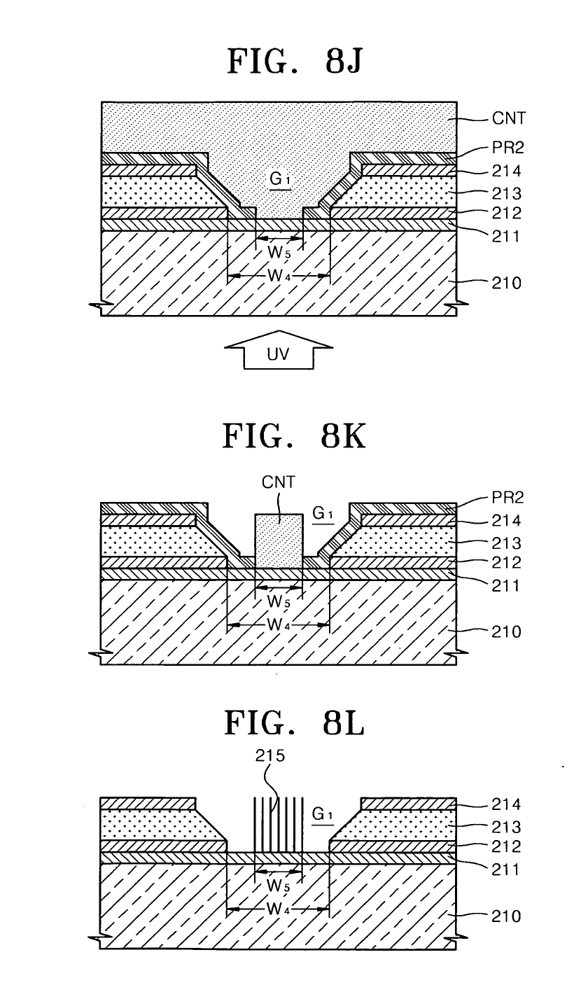

FIGS. 8A through 8I are cross-sectional views illustrating a method of manufacturing the display device of FIG. 2, according to an embodiment of the present invention. Referring to FIG. 8A, a transparent conductive material such as indium-tin-oxide (ITO) is vapor-deposited on a first substrate 210 and a transparent electrode layer 211 having a predetermined thickness t1 is formed by patterning the vapor-deposited transparent conductive layer. Then, a cathode electrode layer 212 is formed as a thin Cr layer having a thickness t2 of approximately 0.2 μm by sputtering Cr components on the transparent electrode layer 211. A dielectric layer 213 is formed by vapor-depositing a dielectric material such as SiO₂ on the cathode electrode layer 212. Here, the SiO₂ dielectric material can be vapor-deposited on the cathode electrode layer 212 so as to have a thickness t3 of approximately 3.0 μm using a plasma enhanced chemical vapor deposition (PECVD) method. Then, a gate electrode layer 214 is formed by sputtering Cr components on the dielectric layer 213 so as to have a thickness t4 of approximately 0.3 μm.

When an electrode structure is formed as described above, patterning is performed in order to form an aperture. Detailed descriptions thereof are as follows. Referring to FIG. 8B, a first photoresist layer PR1 is formed by spin-coating the gate electrode layer 214 with a positive photoresist. Then, the first photoresist layer PR1 is etched to form an opening in the first photoresist layer PR1 having a width W1 of approximately 12.2 μm.

Referring to FIG. 8C, the first photoresist layer PR1 and the gate electrode layer 214 are etched using a continuous etching process such that the opening in the first photoresist layer PR1 having the width W1 is widened to form an opening having a width W2 of approximately 14.3 μm and a depth equal to the combined thickness of the first photoresist layer PR1 and the gate electrode layer 214. The continuous etching process is performed until the dielectric layer 213 is exposed.

Referring to FIG. 8D, the dielectric layer 213 is etched using an etchant which is selectively applied to the dielectric layer 213. Here, the first photoresist layer PR1 and the gate electrode layer 214 function as an etching mask and an exposed portion of the dielectric layer 213 is removed. An under-cut is formed under the etching mask while etching is performed such that an aperture G1 whose upper portion is wider than a lower portion is formed. A sidewall of the aperture G1 is formed to have an inclined surface. Here, a width W3 of the upper portion of the aperture G1 may be approximately 21.5 μm and a width W4 of the lower portion of the aperture G1 may be approximately 18 μm. Thus, the width W2 of the portion of the aperture G1 corresponding to the gate electrode layer 214 is smaller than the width W3 of the upper portion of the aperture G1.

Referring to FIG. 8E, the gate electrode layer 214 is etched so as to expand the width of the portion of the aperture G1 corresponding to the gate electrode layer 214 to the width W3 to correspond to an upper portion of the dielectric layer 213.

Referring to FIG. 8F, the first photoresist layer PR1 is now removed so as to obtain a layered electrode structure.

Referring to FIG. 8G, a second photoresist layer PR2 is formed by forming a positive photoresist on an exposed upper surface of the layered electrode structure of FIG. 8F by a spin-coating method. In more detail, the second photoresist layer PR2 is formed on a top surface of the gate electrode layer 214, on a portion of the transparent electrode layer 211 exposed to the aperture G1, and the sidewall of the aperture G1 from the gate electrode layer 214 to the transparent electrode layer 211.

Referring to FIG. 8H, a photomask MASK is disposed over the second photoresist layer PR2 and the second photoresist layer PR2 is selectively exposed. Here, a portion (having a width W5) of the second photoresist layer PR2 that is exposed corresponds to the open portion (having a width W4) of the cathode electrode layer 212. In general, the width W5 is less than the width W4. Here, since an exposed portion of the second photoresist layer PR2 is softened by an internal optical-chemical reaction, if an appropriate etching process is performed, the exposed portion can be selectively removed as illustrated in FIG. 8I.

Referring to FIG. 8J, a CNT layer CNT is formed by applying a sufficient amount of photosensitive CNT paste on the electrode structure on which the second photoresist layer PR2 is formed. Here the photosensitive CNT paste may be a negative paste in which an exposed portion is selectively hardened. Then, exposing process is performed from a lower surface of the first substrate 210. Here, the opaque second photoresist layer PR2 functions as a photomask for incident (UV) rays. The exposed portion of the CNT layer CNT is hardened by an optical-chemical reaction.

Referring to FIG. 8K, the other portion of the CNT layer CNT excluding the hardened portion can be removed using an appropriate etching process.

Referring to FIG. 8L, the second photoresist layer PR2 is removed. The hardened portion of the CNT layer CNT is burned, and activated so as to function as electron emitters 215.

Once the process described referring to FIG. 8L is completed, barrier ribs can be formed on the first substrate to define emission cells, and emission layers can be formed on the sidewalls of the barrier ribs. Independently from the processes described referring to FIGS. 8A through 8L, a second substrate can be prepared, and visible-light reflection layer is formed on the second substrate. The second substrate can be assembled with the first substrate in a manner that the visible-light reflection layer faces the electrode structures formed on the first substrate. Once the first and second substrates are assembled, the processes for manufacturing the display device of the present invention can be completed.

In a conventional display device using a plasma discharge, a huge amount of energy is required to ionize a discharge gas. On the other hand, in the display device of the present invention, an image can be displayed if the display device has at least the minimum energy to excite the discharge gas by electron beams emitted from electron emitters. Accordingly, the display device of the present invention can have lower driving voltage than the conventional display device, and can have greatly improved luminous efficiency.

In particular, the display device of the present invention is not a transmissive display device which displays an image by transmitting visible light through an emissive layer but is a so-called ‘reflective display device’ which displays an image through apertures formed to expose the electron emitters. Therefore, optical loss, which generally occurs due to low transmittance of the emission layer, is minimized.

Furthermore, unlike a conventional display device, in which the transmittance of the emission layer determines the thickness of the emission layer, the emission layer of the display device according to the present invention can be formed to a desired thickness such that the luminous efficiency can be further improved.

While the present invention has been particularly shown and described with reference to exemplary embodiments thereof, it will be understood by one skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A display device comprising:
a first substrate transmitting visible light;
a second substrate spaced apart from the first substrate by a predetermined interval;
a plurality of transparent electrodes formed on the first substrate;
a plurality of cathode electrodes which contact the transparent electrodes and extend parallel to the transparent electrodes;
a plurality of gate electrodes formed between the first substrate and the second substrate, the gate electrodes extending to cross the cathode electrodes, the gate electrodes and the cathodes electrodes having apertures formed in regions at which the cathode electrodes overlap with the gate electrodes;
a plurality of electron emitters protruding from the transparent electrodes into a space between the first and second substrates through the apertures;
a plurality of barrier ribs which are disposed between the first and second substrates and define one or more emission cells;
a discharge gas which fills the emission cells and generates ultraviolet rays by interactions with electrons emitted from the electron emitters;
a plurality of emission layers which are formed on internal walls of the emission cells and emitting visible light by interactions with the ultraviolet rays; and
a visible-light reflection layer which is formed on the second substrate and reflects the visible light generated from the emission layers toward the first substrate.

2. The display device of claim 1, wherein the electronic emitters are composed of a material including carbon nano-tubes (CNTs).

3. The display device of claim 1, wherein the electron emitters are formed on the transparent electrodes on regions exposed by the apertures.

4. The display device of claim 1, wherein the visible light generated from the emission layers is emitted out of the first substrate through the apertures.

5. The display device of claim 1, wherein one or more apertures are formed in each of the emission cells.

6. The display device of claim 1, wherein each of the cathode electrodes and the gate electrodes are composed of a conductive metallic material.

7. The display device of claim 1, further comprising a dielectric layer that is formed between the cathode electrodes and the gate electrodes, the apertures penetrating the dielectric layer.

8. The display device of claim 7, wherein the dielectric layer is composed of a material comprising SiO₂.

9. The display device of claim 1, wherein the visible-light reflection layer comprises a conductive metallic material.

10. The display device of claim 1, wherein the visible-light reflection layer comprises a conductive material so as to be maintained at a floating status by blocking a voltage applied from an external device.

11. The display device of claim 1, wherein the visible-light reflection layer comprises a conductive material and an anode voltage is applied to the visible-light reflection layer from an external device.

12. The display device of claim 1, wherein voltage (V₁) applied to the cathode electrodes, voltage (V₂) applied to the gate electrodes, and voltage (V₃) applied to the visible-light reflection layer satisfies the relationship of V₁<V₂≦V₃.

13. The display device of claim 1, wherein the emission layers are formed on sidewalls of the barrier ribs and on a portion of the visible-light reflection layer exposed to the emission cells.

14. A method of manufacturing a display device, the method comprising:
forming a transparent electrode layer on a first substrate;
forming a first electrode layer on the transparent electrode layer;
forming a dielectric layer on the first electrode layer;
forming a second electrode layer on the dielectric layer;
forming an aperture on the first electrode layer, the second electrode layer, and the dielectric layer by etching portions of the first and second electrode layers and the dielectric layer, a portion of the transparent electrode layer being exposed through the aperture, the aperture having an inclined surface;
forming a second photoresist layer on the exposed portion of the transparent electrode layer, the inclined surface of the aperture, and the second electrode layer;
forming an opening in a portion of the second photoresist layer that is formed on the exposed portion of the transparent electrode layer by selectively removing the second photoresist layer;
forming a photosensitive carbon nano-tube layer inside the opening and the aperture;
applying ultraviolet rays to the photosensitive carbon nano-tube layer through the first substrate, a portion of the photosensitive carbon nano-tube layer that is exposed by the ultraviolet rays being hardened;
removing the photosensitive carbon nano-tube layer excluding the hardened portion of the photosensitive carbon nano-tube layer; and
burning and activating the remaining hardened portion of the photosensitive carbon nano-tube layer.

15. The method of claim 14, wherein the forming of the aperture comprises:
forming a first photoresist layer on the second electrode layer, the first photoresist layer having a first opening through which a portion of the second electrode layer is exposed;
removing the portion of the second electrode layer exposed through the first opening, a portion of the dielectric layer being exposed through the removed portion of the second electrode layer;
etching the exposed portion of the dielectric layer, a portion of the first electrode layer being exposed through the etched portion of the dielectric layer; and
removing the exposed portion of the first electrode layer.

16. The method of claim 14, wherein a width of the aperture formed around an interface between the dielectric layer and the second electrode layer is larger than a width of the aperture formed around an interface between the dielectric layer and the first electrode layer.

17. The method of claim 14, wherein a width of the opening formed on the second photoresist layer is smaller than a width of the portion of the transparent electrode layer being exposed through the aperture.
